(19) United States
(12) Patent Application Publication
(10) Pub. No.: US 2026/0201093 A1
(43) Pub. Date: Jul. 16, 2026

(54) PROCESS FOR PRODUCING HIGH-FLOW HETEROPHASIC PROPYLENE COPOLYMER COMPOSITIONS

(71) Applicant: BOREALIS AG, Vienna (AT)

(72) Inventors: Pauli LESKINEN, Porvoo (FI); Jingbo WANG, Linz (AT); Markus GAHLEITNER, Linz (AT); Klaus BERNREITNER, Linz (AT)

(73) Assignee: BOREALIS AG, Vienna (AT)

(21) Appl. No.: 19/126,039

(22) PCT Filed: Oct. 31, 2023
(86) PCT No.: PCT/EP2023/080298

§ 371 Date: Apr. 30, 2025

(30) Foreign Application Priority Data
Oct. 31, 2022 (EP) 22204691.4

(51) Int. Cl. C08F 210/06

(52) U.S. Cl. CPC C08F 210/06

(57) ABSTRACT

The present invention concerns a process for producing a heterophasic propylene copolymer composition, the process comprising the steps of a) preparing a bimodal matrix phase (A) of a heterophasic propylene copolymer by a1) polymerizing in a first reactor propylene to obtain a first propylene polymer fraction having a melt flow rate MFR2 of 25 to 85 g/10 min determined according to ISO 1133 at 230° C. and 2.16 kg load, a2) transferring the first propylene polymer fraction to a second reactor, and polymerizing in the second reactor propylene to obtain a second propylene polymer fraction, the combined first and second propylene polymer fractions having an MFR2 determined according to ISO 1133 at 230° C. and 2.16 kg load being at least 2.2 times higher than the MFR2 of the first propylene polymer fraction, b) preparing a disperse phase (B) of the heterophasic propylene copolymer by b1) transferring the first propylene polymer fraction and the second propylene polymer fraction to a third reactor, and polymerizing in the third reactor propylene and an alpha-olefin having 2 or 4 to 10 carbon atoms obtain a third propylene polymer fraction, c) withdrawing the heterophasic propylene copolymer comprising the first, second and third propylene polymer fraction, and d) obtaining the heterophasic propylene copolymer composition comprising the heterophasic propylene copolymer, wherein the heterophasic propylene copolymer composition has a melt flow rate MFR2 of 75 to 250 g/10 min determined according to ISO 1133 at 230° C. and 2.16 kg load, and wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I).

The present invention concerns a process for producing a heterophasic propylene copolymer composition and a heterophasic propylene copolymer composition obtained by this process.

The need for heterophasic propylene copolymers with excellent stiffness at high flowability is constantly increasing as down-gauging and light-weighing become more important with the need for saving energy resources. High flowability polypropylenes are typically used in moulding and particularly in the automotive business where injection molding is the preferred conversion process.

Additionally, the addition of high flow homopolymers with excellent impact stiffness balance allows increasing the MFR of automotive compounds without losing the needed mechanical performance.

From a process perspective, one issue is the balance of the production rate in different reactors in a multistage propylene polymerization process.

In a two-reactor system or in a multistage polymerization process one of the most important parameters is the reactor balance and reactor split between the reactors. This is important from plant economy point of view, but also from the product properties point of view.

Typically, the production split in a two-reactor system is between 40/60 and 60/40%, and if in a 3^{rd} reactor, an elastomer for a heterophasic copolymer is produced, the reactor split is typically in the last reactor from 5 to 30%. In four-reactor mode, two rubber gas phase reactors (GPR) are typically used, and the total split for the heterophasic product can be 10-40%, with the split between rubber GPRs being from 50/50 to 90/10%. In case of a tri-modal process, typically, the first three reactors are producing homo PP or random PP and the split can be for example 45/35/20%.

However, in each reactor system described above, a problem that needs to be solved is how to get the production split controlled according to the plant design. Otherwise, the plant may be running on low speed, low productivity and the plant economy is thus worse.

One of the main causes for the above mentioned problem is a poor bulk density (BD) of the polymer. Further, one reason for the poor bulk density is a too high MFR2 of the polymer. If the MFR2 is over 80 g/10 min, the polymer is generally more porous and brittle and therefore the bulk density is lower. The mass of the polymer is lower when the bulk density is lower, i.e., the polymer has more volume. In addition, longer residence times in the polymerization reactors may lead to a production rate and a productivity which are lower.

It is therefore an object of the present invention to provide a process for the production of a heterophasic propylene copolymer composition, which overcomes the above-mentioned problems.

It is also an object of the invention to provide a process for the production of a heterophasic propylene copolymer composition, in particular a metallocene-catalyzed heterophasic propylene copolymer composition, having an improved balance of stiffness and impact strength.

It is a further object of the invention to provide such a process, which allows an improved production and plant speed and thus improved reactor balance and plant economy.

It now has been surprisingly found that above-mentioned objects can be achieved by a process for producing a heterophasic propylene copolymer composition, the process comprising the steps of
a) preparing a bimodal matrix phase (A) of a heterophasic propylene copolymer by
   a1) polymerizing propylene in a first reactor to obtain a first propylene polymer fraction having a melt flow rate MFR2 of 25 to 85 g/10 min, determined according to ISO 1133 at 230° C. and 2.16 kg load,
   a2) transferring the first propylene polymer fraction to a second reactor, and polymerizing propylene in the second reactor to obtain a second propylene polymer fraction, the combined first and second propylene polymer fractions having an MFR2 determined according to ISO 1133 at 230° C. and 2.16 kg load being at least 2.2 times higher than the MFR2 of the first propylene polymer fraction,
b) preparing a disperse phase (B) of the heterophasic propylene copolymer by
   b1) transferring the first propylene polymer fraction and the second propylene polymer fraction to a third reactor, and polymerizing in the third reactor propylene and an alpha-olefin having 2 or 4 to 12 carbon atoms to obtain a third propylene polymer fraction,
c) withdrawing from the third reactor the heterophasic propylene copolymer comprising the first, second and third propylene polymer fraction, and
d) obtaining the heterophasic propylene copolymer composition comprising the heterophasic propylene copolymer.
wherein the heterophasic propylene copolymer composition has a melt flow rate MFR2 of 70 to 250 g/10 min determined according to ISO 1133 at 230° C. and 2.16 kg load, and
wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I):

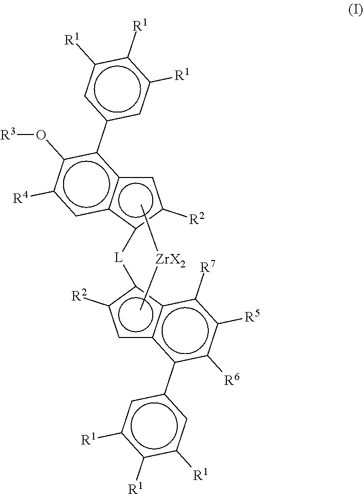

wherein each X independently is a sigma-donor ligand,
L is a divalent bridge selected from —R′₂C—, —R′₂C—CR′₂—, —R′₂Si—, —R′₂Si—SiR′₂—, and —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or different and are a CH₂—R⁸ group, with R⁸ being H or linear or branched C₁₋₆-alkyl group, C₃₋₈-cycloalkyl group, or C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and is selected from a C₁-C₂₀-hydrocarbyl group and a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

The above objects are thus solved by a moderate broadening of the molecular weight distribution (MWD) of the polypropylene homopolymer for the matrix, i.e. a bimodal production. The moderate broadening and bimodal production of the polypropylene homopolymers means producing higher weight average molecular weight (Mw) (i.e. low melt flow rate (MFR)) polypropylene homopolymer in the first reactor and lower Mw (i.e. high melt flow rate (MFR)) polypropylene homopolymer in the second reactor.

The present invention offers a number of advantages. The significantly improved flowability may enable the use of the polypropylene homopolymers in molding applications, particularly injection molding applications. The excellent flowability is further accompanied by high stiffness. High stiffness is important for numerous polypropylene uses. Also, the invention may enable an easier optimization of stiffness versus impact strength balance, and in particular a higher propylene-ethylene rubber content could be reached.

At the same time, the process according to the invention may be beneficial in terms of economy of the plant and reactor balance. A fine tuning of a desired split between the reactors can be achieved by molecular weight Mw or melt flow rate control, which in turn can be controlled by the hydrogen feed. This may lead to the benefit of higher total productivity of the catalyst and/or better morphology of the polymer powder, and/or to improved bulk density (BD). In this context, “Bulk density” (or “fluidized bed density” for fluidized bed polymerization reactors) denotes mass of polymer powder divided by the volume of the reactor, excluding an optional disengaging zone that might be present in said reactor.

When high Mw polypropylene homopolymer is produced in the first reactor, low amount of hydrogen is used for the Mw control and thus reactivity is lower. In the second polymerization reactor a lower Mw polypropylene homopolymer is produced than the Mw produced in the first reactor, thus more hydrogen is needed which accelerates the production and which helps in split control. This is important since as a function of time, a decay of the polymerization reaction is seen due to the catalyst living time.

In other words, the ratio H2/C3 in both the first and second reactor can be adjusted so as to produce a higher Mw polypropylene homopolymer in the first reactor and to produce a lower Mw polypropylene homopolymer in the second reactor having an Mw lower than the higher Mw polypropylene homopolymer produced in the first reactor. The combined higher Mw polypropylene homopolymer and lower higher Mw polypropylene homopolymer form a bimodal polypropylene homopolymer for the matrix. Thus, a broadened MWD and a desired melt flow rate MFR of the polypropylene homopolymer for the matrix of the heterophasic propylene copolymer can be achieved.

Apart from using hydrogen, also the split ratio between the first reactor and the second reactor can be adjusted to control the weight average molecular weight (Mw), and thus the melt flow rate MFR, of the polypropylene homopolymer for the matrix.

In practice, typically the split ratio between the first reactor and the second reactor as well as the adjustment of the Mw, and thus of the melt flow rate (MFR) of the polypropylene homopolymer produced in the second reactor are used to produce the desired polypropylene homopolymer for the matrix.

The expression “homopolymer” as used herein relates to a polypropylene that consists substantially, i.e., of at least 99.5 wt.-%, more preferably of at least 99.8 wt.-%, of propylene units. In a preferred embodiment, only propylene units in the propylene homopolymer are detectable.

The “modality” of a polymer refers to the form of its molecular weight distribution curve, i.e. the shape of a curve representing the polymer weight fraction as function of its molecular weight. If the polymer is produced in a sequential step process, utilizing reactors coupled in series and using different conditions in each reactor, the different fractions produced in the different reactors will each have their own molecular weight distribution. When the molecular weight distribution curves from these fractions are superimposed onto the molecular weight distribution curve for the total resulting polymer product, that curve will show two or more maxima or at least be distinctly broadened in comparison with the curves for the individual fractions. Such a polymer product, produced in two or more serial steps, is called bimodal or multimodal depending on the number of steps. In the following all polymers thus produced in two or more sequential steps are called “multimodal”. It is noted that also the chemical compositions of the different fractions may be different.

As used herein, the term “unimodal matrix” means that the difference in the MFR2 (230° C., 2.16 kg) between the propylene polymer fractions contained by the matrix, is at most 15%, preferably at most 10%. For example, with reference to the present invention, it is considered that a unimodal matrix is produced if the difference between the MFR2 of the first propylene polymer fraction produced in the first reactor and the MFR2 of the second propylene polymer fraction produced in the second reactor is at most 15%, preferably at most 10%.

### Heterophasic Propylene Copolymer

The heterophasic propylene copolymer comprises a bimodal matrix phase (A) and a disperse phase (B) dispersed within the bimodal matrix phase (A). The heterophasic propylene copolymer preferably consists of a bimodal matrix phase (A) and a disperse phase (B) dispersed within the bimodal matrix phase (A).

In step a) of the process of the invention, the bimodal matrix phase (A) of the heterophasic propylene copolymer is produced, whereas in step b) of the process of the invention, the disperse phase (B) of the heterophasic propylene copolymer is produced.

The first propylene polymer fraction has a melt flow rate MFR2 of 25 to 85 g/10 min, preferably of 35 to 75 g/10 min determined according to ISO 1133 at 230° C. and 2.16 kg load.

The second propylene polymer fraction preferably has a calculated melt flow rate MFR2 (230° C., 2.16 kg load) of from 150 to 2500 g/10 min, preferably of from 250 to 2200 g/10 min, more preferably of from 500 to 1900 g/10 min, more preferably of from 700 to 1600 g/10 min.

Preferably, the first propylene polymer fraction and/or the second propylene polymer fraction is/are propylene homopolymer fraction(s) and/or the third propylene polymer fraction is an ethylene-propylene rubber fraction.

The matrix phase (A) produced in step a) is bimodal. Preferably, the combined first propylene polymer fraction and the second propylene polymer fraction form a bimodal propylene composition, preferably a bimodal propylene homopolymer composition.

Preferably, the combined first and the second propylene polymer fractions have a melt flow rate MFR2 of 120 to 500 g/10 min, preferably 130 to 400 g/10 min, determined according to ISO 1133 at 230° C. and 2.16 kg load.

The combined first and second propylene polymer fractions have an MFR2 determined according to ISO 1133 at 230° C. and 2.16 kg load which is at least 2.2 times higher, preferably at least 2.5 times higher, more preferably at least 2.8 times, most preferably at least 4.0 times higher than the MFR2 of the first propylene polymer fraction. Usually, the combined first and second propylene polymer fractions have an MFR2 determined according to ISO 1133 at 230° C. and 2.16 kg load being preferably at most 30.0 times higher, more preferably at most 25.0 times higher, most preferably at most 20.0 times higher than the MFR2 of the first propylene polymer fraction.

Preferably, the combined first and the second propylene polymer fractions have a fraction soluble in cold xylene at 25° C. (XCS fraction) determined according to ISO 16152 in an amount of less than 2.0 wt.-%, preferably in the range of 0.3 to 1.8 wt.-%, based on the total weight of the combined first and the second propylene polymer fractions.

Preferably, the first propylene polymer fraction is produced in an amount of from 35 to 70 wt.-%, based on the total weight of the combined first, second and third propylene polymer fraction, and/or
the second propylene polymer fraction is produced in an amount of from 25 to 55 wt.-%, based on the total weight of the combined first, second and third propylene polymer fraction, and/or
the third propylene polymer fraction is produced in an amount of from 2 to 25 wt.-% or 5 to 25 wt.-%, based on the total weight of the combined first, second and third propylene polymer fraction.

More preferably, the first propylene polymer fraction is produced in an amount of from 35 to 70 wt.-%, based on the total weight of the combined first, second and third propylene polymer fraction, and
the second propylene polymer fraction is produced in an amount of from 25 to 55 wt.-%, based on the total weight of the combined first, second and third propylene polymer fraction, and
the third propylene polymer fraction is produced in an amount of from 2 to 25 wt.-% or 5 to 25 wt.-%, based on the total weight of the combined first, second and third propylene polymer fraction.

More preferably the first propylene polymer fraction is produced in an amount of from 45 to 65 wt.-%, based on the total weight of the combined first, second and third propylene polymer fraction, and/or
the second propylene polymer fraction is produced in an amount of from 30 to 50 wt.-%, based on the total weight of the combined first, second and third propylene polymer fraction, and/or
the third propylene polymer fraction is produced in an amount of from 7 to 20 wt.-%, based on the total weight of the combined first, second and third propylene polymer fraction.

Most preferably the first propylene polymer fraction is produced in an amount of from 45 to 65 wt.-%, based on the total weight of the combined first, second and third propylene polymer fraction, and
the second propylene polymer fraction is produced in an amount of from 30 to 50 wt.-%, based on the total weight of the combined first, second and third propylene polymer fraction, and
the third propylene polymer fraction is produced in an amount of from 7 to 20 wt.-%, based on the total weight of the combined first, second and third propylene polymer fraction.

Preferably, the first propylene polymer fraction is produced in an amount of from 70 to 40 wt.-%, based on the total weight of the combined first and second propylene polymer fraction, and the second propylene polymer fraction is produced in an amount of from 30 to 60 wt.-%, based on the total weight of the combined first and second propylene polymer fraction.

Preferably, the first reactor is a slurry reactor, the slurry reactor preferably being a loop reactor, and/or wherein the second reactor is a first gas phase reactor (GPR1) and/or wherein the third reactor is a second gas phase reactor (GPR2).

The first reactor is preferably a slurry phase reactor, such as a loop reactor. It is preferred that the operating temperature in the first reactor, preferably the loop reactor, is in the range from 60 to 90° C., more preferably in the range from 65 to 85° C., still more preferably in the range from 67 to 80° C.

Typically, the pressure in the first reactor, preferably in the loop reactor, is in the range from 20 to 80 bar, preferably 30 to 70 bar, more preferably 48 to 58 bar.

It is preferred that in the first reactor, preferably the loop reactor, a propylene homopolymer is produced. Thus, it is preferred that the first propylene polymer fraction is a propylene homopolymer fraction.

Preferably hydrogen is added in the first reactor in order to control the molecular weight, i.e. the melt flow rate MFR2. Preferably, in step a1) a ratio of the feed of hydrogen to the feed of propylene is from 0.10 to below 0.40 mol/kmol, preferably from 0.15 to 0.39 mol/kmol, more preferably from 0.20 to 0.38 mol/kmol, more preferably from 0.20 to 0.38 mol/kmol, and most preferably from 0.20 to 0.36 mol/kmol. It is noted that already small variations of the ratio of the feed of hydrogen to the feed of propylene in the first reactor may lead to significant changes of the melt flow rate of the first propylene polymer fraction.

The average residence time in the first reactor, preferably the loop reactor, is typically from 15 to 120 min, preferably from 20 to 80 min. As it is well known in the art the average residence time T can be calculated from equation (1) below:

$$τ = \frac{{V}_{R}}{{Q}_{o}} \qquad equation ( 1 )$$

wherein
V_{R} is the volume of the reaction space (in case of a loop reactor, the volume of the reactor, in case of the fluidized bed reactor, the volume of the fluidized bed)
Qₒ is the volumetric flow rate of the product stream (including the polymer product and the fluid reaction mixture).

The production rate is suitably controlled by the catalyst feed rate and the polymerization temperature. It is also possible to influence the production rate by suitable selection of the monomer concentration. The desired monomer concentration can then be achieved by suitably adjusting the propylene feed rate.

The second reactor preferably is a first gas phase reactor (GPR1), such as a first fluidized bed gas phase reactor. It is preferred that the operating temperature in the second reactor, preferably the first gas phase reactor, is in the range from 65 to 95° C., more preferably in the range from 70 to 90° C.

Preferably, the pressure in the second reactor, preferably in the first gas phase reactor, is in the range from 5 to 50 bar, preferably 20 to 30 bar.

The average residence time in the second reactor, preferably the first gas phase reactor, is typically 30 to 130 min. Reference is made to equation (1) above.

It is preferred that in the second reactor, preferably the first gas phase reactor, a propylene homopolymer is produced. Thus, it is preferred that the second propylene polymer fraction is a propylene homopolymer fraction.

Preferably hydrogen is added in the second reactor in order to control the molecular weight, i.e. the melt flow rate MFR2. Preferably, in step a2) the hydrogen to propylene feed ratio (H2/C3 ratio) in the second reactor, preferably the first gas phase reactor, is in the range from more than 4.65 to 10.0 mol/kmol, more preferably from 4.90 to 8.00 mol/kmol, more preferably from 5.10 to 6.00 mol/kmol, more preferably from 5.20 to 5.80 mol/kmol, and most preferably from 5.30 to 5.70 mol/kmol. It is noted that already small variations of the ratio of the feed of hydrogen to the feed of propylene in the second reactor may lead to significant changes of the melt flow rate of the second propylene polymer fraction.

The third reactor is positioned downstream of the second reactor and is preferably a gas phase reactor. In case both the second and third reactors are gas phase reactors, the second reactor is referred to herein for simplicity as the first gas phase reactor and the third reactor is referred to as the second gas phase reactor (GPR2). Preferably, the third reactor is a fluidized bed gas phase reactor. It is preferred that the operating temperature in the third reactor, is in the range from 60 to 90° C., more preferably in the range from 65 to 85° C. These temperatures are also applicable if the third reactor is a gas phase reactor. Typically, the operating temperature in third reactor is lower than the operating temperature in the second reactor. Typically, the pressure in the third reactor, is in the range from 5 to 50 bar, preferably 20 to 30 bar. These pressures are also applicable if the third reactor is a gas phase reactor.

The average residence time in the third reactor, is typically 30 to 130 min. Reference is made to equation (1) above. These times are also applicable if the third reactor is a gas phase reactor.

In the third reactor, the disperse phase (B) of the heterophasic propylene copolymer is produced, i.e. a copolymer of propylene and a comonomer selected from alpha-olefins having 2 or 4 to 12 carbon atoms as comonomer, preferably alpha-olefins having 2 or 4 to 10 carbon atoms, more preferably ethylene, 1-butene and/or 1-hexene, even more preferably ethylene and/or 1-butene and most preferably ethylene as comonomer is produced. Preferably, in the third reactor, a propylene ethylene copolymer is produced. Thus, the third propylene polymer fraction is preferably a propylene ethylene copolymer fraction.

The ethylene to propylene feed ratio (C2/C3 ratio) in the third reactor, is preferably in the range from 700 to 1000 mol/kmol, more preferably 800 to 950 mol/kmol. These C2/C3 ratios are also applicable if the third reactor is a gas phase reactor.

Preferably, the hydrogen to ethylene feed ratio (H2/C2 ratio) in the third reactor, is in the range from 0.5 to 3.5 mol/kmol, more preferably 1.0 to 2.5 mol/kmol. These H2/C3 ratios are also applicable if the third reactor is a gas phase reactor.

The combined first, second and third propylene polymer fractions form the heterophasic propylene copolymer. In other words, the heterophasic propylene copolymer of the invention comprises the combined first, second and third propylene polymer fractions. Preferably, the heterophasic propylene copolymer of the invention consists of the combined first, second and third propylene polymer fractions.

Multistage reactor designs containing a series of different types of reactors and operating with a slurry-gas phase process, are known, an example thereof including the technology developed by Borealis and known as Borstar®. The process of the invention preferably uses the multistage reactor design of the Borstar® technology as detailed in EP 0 887 379 A1 and EP 0 517 868 A1 while operating the different reactors with the parameters (temperature, pressure, residence time, feed ratios, etc.) as enumerated hereinabove.

The preparation of the first, second and third propylene polymer fractions can comprise in addition to the (main) polymerization stages in the at least three reactors prior thereto a pre-polymerization in a pre-polymerization reactor upstream of the first reactor.

In the pre-polymerization reactor, a polypropylene is produced. The pre-polymerization is conducted in the presence of the metallocene catalyst system. However, this shall not exclude the option that at a later stage for instance further cocatalyst is added in the polymerization process, for instance in the first reactor.

In one embodiment, all components of the metallocene catalyst system are only added in the pre-polymerization reactor, if a pre-polymerization is applied.

The pre-polymerization reaction is typically conducted at a temperature of 15 to 40° C., preferably from 17 to 35° C. The pressure in the pre-polymerization reactor is not critical but must be sufficiently high to maintain the reaction mixture in liquid phase. Thus, the pressure may be from 20 to 100 bar, preferably 45 to 55 bar. The average residence time in the pre-polymerization reactor is typically 0.2 to 1.0 h, preferably 0.25 to 0.75 h, and most preferably 0.28 to 0.6 h. Reference is made to equation (1) above.

In a preferred embodiment, the pre-polymerization is conducted as bulk slurry polymerization in liquid propylene, wherein the liquid phase comprises propylene, with optionally inert components dissolved therein.

It is possible to add other components also to the pre-polymerization stage. Thus, hydrogen may be added into the pre-polymerization stage to control the molecular weight of the polypropylene during the pre-polymerisation. The precise control of the pre-polymerization conditions and reaction parameters is within the skill of the art.

Due to the above defined process conditions in the pre-polymerization, preferably a mixture of the metallocene catalyst system and the polypropylene produced in the pre-polymerization reactor is obtained. Preferably, the metallocene catalyst system is (finely) dispersed in the polypropylene. In other words, the metallocene catalyst particles introduced in the pre-polymerization reactor are split into smaller fragments that are evenly distributed within the growing polypropylene. The sizes of the introduced metallocene catalyst particles as well as of the obtained fragments are not of essential relevance for the instant invention and within the skilled person's knowledge.

As mentioned above, if a pre-polymerization is used, subsequent to said pre-polymerization, the mixture of the metallocene catalyst system and the polypropylene produced in the pre-polymerization reactor is transferred to the first reactor. Typically, the total amount of the polypropylene produced in the pre-polymerization reactor and in the first, second and third propylene polymer fractions is rather low and typically not more than 5.0 wt.-%, more preferably not more than 4.0 wt.-%, still more preferably in the range from 0.1 to 4.0 wt.-%, like in the range 0.5 of to 3.0 wt.-%.

In case that pre-polymerization is not used, propylene and the other ingredients such as the metallocene catalyst system are directly introduced into the first reactor.

Preferably, the process further comprises the step of
b2) transferring the first propylene polymer fraction, the second polymer fraction and the third propylene copolymer fraction to a fourth reactor, the fourth reactor preferably being a gas phase reactor (referred to herein as the third gas phase reactor—GPR3), and polymerizing in the fourth reactor propylene and an alpha-olefin having 2 or 4 to 12 carbon atoms to obtain a fourth propylene polymer fraction, the fourth propylene polymer fraction preferably being an ethylene-propylene rubber fraction.
   wherein step b2) takes place after step b1) and before step c).

All the operating conditions and parameters, such as temperature, pressure, residence time, hydrogen feed, comonomer, of the second gas phase reactor (GPR2) as described above can be equally used in the third gas phase reactor also (GPR3).

In step c) the heterophasic propylene copolymer comprising the first, second and third propylene polymer fraction is withdrawn. Preferably the heterophasic propylene copolymer comprising the first, second, third and fourth propylene polymer fraction is withdrawn. More preferably, in step c) the heterophasic propylene copolymer consisting of the first, second and third propylene polymer fraction is withdrawn, and most preferably the heterophasic propylene copolymer consisting of the first, second, third and fourth propylene polymer fraction is withdrawn.

Preferably, the heterophasic propylene copolymer comprises a fraction soluble in cold xylene at 25° C. (XCS fraction) determined according to ISO 16152 in an amount in the range of 6 to 22 wt.-%, more preferably 7 to 20 wt.-%, more preferably 8 to 18 wt.-%, based on the total weight of the heterophasic propylene copolymer.

Preferably, the fraction soluble in cold xylene at 25° C. (XCS fraction) of the heterophasic propylene copolymer has an ethylene content (C2(XCS)) of 15 to 30 wt.-%, preferably 18 to 28 wt.-%, more preferably 20 to 26 wt.-%, based on the total weight of the XCS fraction as determined by Fourier transform infrared spectroscopy (FTIR) calibrated with ¹³C-NMR spectroscopy.

Preferably, the fraction soluble in cold xylene at 25° C. (XCS fraction) of the heterophasic propylene copolymer has an intrinsic viscosity (IV(XCS)) of 1.8 to 3.2 dl/g, preferably of 2.0 to 3.0 dl/g and most preferably of 2.2 to 2.8 dl/g as determined in decalin according to ISO 1628-3.

Preferably, the heterophasic propylene copolymer has a total ethylene content (C2 total) in the range of 1.8 to 6.5 wt.-%, more preferably 1.9 to 6.0 wt.-%, most preferably 2.0 to 5.5 wt.-%, based on the total weight of the heterophasic propylene copolymer as determined by Fourier transform infrared spectroscopy (FTIR) calibrated with ¹³C-NMR spectroscopy.

Preferably, the heterophasic propylene copolymer has a bulk density of more than 300 kg/m³, such as more than 300 to 600 kg/m³, more preferably of 350 to 500 kg/m³.

Preferably, the heterophasic propylene copolymer has a ratio IV(XCS)/XCS of 180 to 350 ml/g, more preferably 250 to 350 ml/g and most preferably 270 to 350 ml/g.

Preferably, the heterophasic propylene copolymer has an MFR2 of 70 to 250 g/10 min, preferably 70 to 200 g/10 min, more preferably 75 to 150 g/10 min, most preferably 80 to 120 g/10 min, determined according to ISO 1133 at 230° C. and 2.16 kg load determined according to ISO 1133 at 230° C. and 2.16 kg load.

### Heterophasic Propylene Copolymer Composition

In step d) the heterophasic propylene copolymer composition comprising the heterophasic propylene copolymer is obtained. Preferably, in step d) the heterophasic propylene copolymer composition consisting of the heterophasic propylene copolymer is obtained.

Preferably, the heterophasic propylene copolymer composition has an MFR2 of 70 to 250 g/10 min, preferably 70 to 200 g/10 min, more preferably 75 to 150 g/10 min, most preferably 80 to 120 g/10 min, determined according to ISO 1133 at 230° C. and 2.16 kg load determined according to ISO 1133 at 230° C. and 2.16 kg load.

Preferably, the heterophasic propylene copolymer composition has a melting temperature Tm in the range of 145 to 160° C., preferably in the range of 148 to 158° C., determined by differential scanning calorimetry (DSC) according to ISO 11357.

Preferably, the heterophasic propylene copolymer composition has a crystallization temperature T_{c} in the range of 110 to 120° C. determined by differential scanning calorimetry (DSC) according to ISO 11357.

Apart from the heterophasic propylene copolymer, the heterophasic propylene copolymer composition may comprise one or more other components. Preferably, the heterophasic propylene copolymer composition further comprises an additive. The additive may be present in an amount of 0.1 to 5.0 wt.-%, based on the total weight of the heterophasic propylene copolymer composition.

The additive may be one compound or a mixture of two or more compounds. Preferably, the additive comprises one or more antioxidant(s), a UV stabilizer, an antistatic agent, an acid scavenger, a nucleating agent, carbon black or a mixture thereof, more preferably the additive consists of one or more antioxidant(s), a UV stabilizer, an antistatic agent, an acid scavenger, a nucleating agent, carbon black or a mixture thereof. At least one additive may be added to the composition in the form of a masterbatch. Preferably, carbon black is in the form of a carbon black masterbatch.

Such additives are commercially available and for example described in “Plastic Additives Handbook”, 6th edition 2009 of Hans Zweifel (pages 1141 to 1190).

### Metallocene Catalyst System

The heterophasic propylene copolymer composition is prepared in the presence of a metallocene catalyst system, preferably in the presence of at least one metallocene catalyst system.

The metallocene catalyst system may be any supported metallocene catalyst system suitable for the production of heterophasic propylene copolymers.

It is preferred that the metallocene catalyst system comprises (i) a metallocene complex, (ii) a cocatalyst system comprising a boron-containing cocatalyst and/or aluminoxane cocatalyst, and (iii) a support, preferably a support comprising silica, more preferably a support consisting of silica.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′₃, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like Cl, or methyl or benzyl. A preferred monovalent anionic ligand is halogen, in particular chlorine (Cl).

More information, in particular about the preparation of such a catalyst, can be found e.g. in WO 2013/007650 A1.

Preferred metallocene complexes (i) of the metallocene catalyst include:
rac-dimethylsilanediylbis[2-methyl-4-(3′,5′-dimethylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl]zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl]zirconium dichloride,
   or their corresponding zirconium dimethyl analogues.

Especially preferred is rac-anti-dimethylsilanediyl[2-methyl-4,8-bis-(3′,5′-dimethylphenyl)-1,5,6,7-tetrahydro-s indacen-1-yl][2-methyl-4-(3′,5′-dimethylphenyl)-5-methoxy-6-tert-butylinden-1-yl]zirconium dichloride.

Also especially preferred, the metallocene catalyst system comprises a metallocene complex (i) of formula (II):

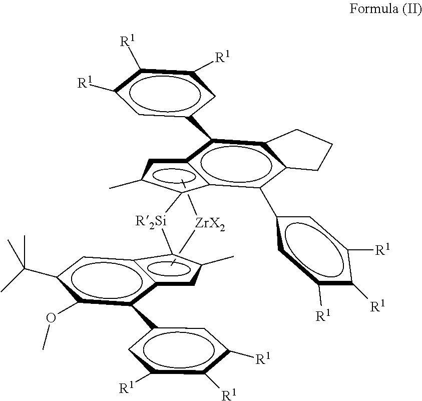

wherein each R¹ are independently the same or can be different and are hydrogen or a linear or branched C₁-C₆ alkyl group, whereby at least on R¹ per phenyl group is not hydrogen,
R′ is a C₁-C₁₀ hydrocarbyl group, preferably a C₁-C₄ hydrocarbyl group and more preferably a methyl group and X independently is a hydrogen atom, a halogen atom, C₁-C₆ alkoxy group, C₁-C₆ alkyl group, phenyl or benzyl group.

Most preferably, X is chlorine, benzyl or a methyl group. Preferably, both X groups are the same. The most preferred options are two chlorides, two methyl or two benzyl groups, especially two chlorides.

Especially preferred is rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride according to formula (III):

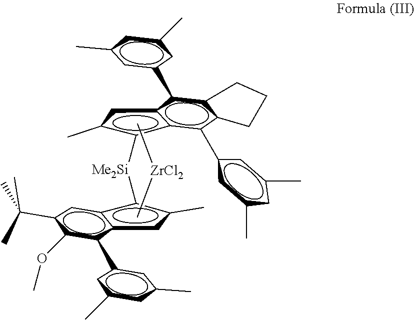

The ligands required to form the complexes and hence catalysts of the invention can be synthesized by any process and the skilled organic chemist would be able to devise various synthetic protocols for the manufacture of the necessary ligand materials. For example, WO 2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959 in which the most preferred catalyst of the present invention is described.

### Cocatalyst System

Preferably, the metallocene catalyst system further comprises (ii) a cocatalyst system comprising a boron containing co-catalyst and/or an aluminoxane co-catalyst.

The aluminoxane cocatalyst can be one of formula (IV):

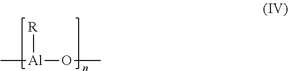

where n is usually from 6 to 20 and R has the meaning below.

Aluminoxanes are formed on partial hydrolysis of organoaluminum compounds, for example those of the formula AIR₃, AIR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (IV).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

Also, a boron containing cocatalyst can be used instead of the aluminoxane cocatalyst or the aluminoxane cocatalyst can be used in combination with a boron containing cocatalyst.

It will be appreciated by the person skilled in the art that where boron based cocatalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used, the metallocene complex is in its alkylated version, that is for example a dimethyl or dibenzyl metallocene complex can be used.

Boron based cocatalysts of interest include those of formula (V)

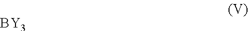

wherein Y is the same or different and is a hydrogen atom, an alkyl group of from 1 to about carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris (3,4,5-trifluorophenyl)borane.

Particular preference is given to tris(pentafluorophenyl)borane.

However it is preferred that borates are used, i.e. compounds containing a borate 3+ ion.

Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
triethylammoniumtetra(phenyl)borate, tributylammoniumtetra(phenyl)borate, trimethylammoniumtetra(tolyl)borate, tributylammoniumtetra(tolyl)borate, tributylammoniumtetra(pentafluorophenyl)borate, tripropylammoniumtetra(dimethylphenyl)borate, tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N,N-diethylaniliniumtetra(phenyl)borate, N,N-dimethylaniliniumtetrakis(pentafluorophenyl)borate, N,N-di(propyl)ammoniumtetrakis(pentafluorophenyl)borate, di(cyclohexyl)ammoniumtetrakist(pentafluorophenyl)borate, triphenylphosphoniumtetrakis(phenyl)borate, triethylphosphoniumtetrakis(phenyl)borate, diphenylphosphoniumtetrakis(phenyl)borate, tri(methylphenyl)phosphoniumtetrakis(phenyl)borate, tri(dimethylphenyl)phosphoniumtetrakis(phenyl)borate, triphenylcarbeniumtetrakis(pentafluorophenyl)borate, or ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate.

It has been surprisingly found that certain boron cocatalysts are especially preferred.

Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

According to the present invention, the preferred cocatalysts are aluminoxanes, more preferably methylaluminoxanes, combinations of aluminoxanes with Al-alkyls, boron or borate cocatalysts, and combination of aluminoxanes with boron-based cocatalysts.

Suitable amounts of cocatalyst will be well known to the person skilled in the art.

The molar ratio of boron to the metal ion of the metallocene may be in the range 0.5:1 to 35 10:1 mol/mol, preferably 1:1 to 10:1 mol/mol, especially 1:1 to 5:1 mol/mol.

The molar ratio of Al in the aluminoxane to the metal ion of the metallocene may be in the range 1:1 to 2000:1 mol/mol, preferably 10:1 to 1000:1 mol/mol, and more preferably 50:1 to 500:1 mol/mol.

The metallocene catalyst system used in the polymerization process of the present invention is used in supported form. The support (iii) used comprises silica, more preferably the support (iii) used consists of silica. In other words, the support is preferably a silica support. The person skilled in the art is aware of the procedures required to support a metallocene catalyst.

Especially preferably, the support is a porous material so that the metallocene complex may be loaded into the pores of the support, e.g. using a process analogous to those described in WO 94/14856 (Mobil), WO 95/12622 (Borealis) and WO 2006/097497.

The average particle size of the support can be typically from 10 to 100 μm. However, it has turned out that special advantages can be obtained if the support has an average particle size from 15 to 80 μm, preferably from 18 to 50 μm.

The particle size distribution of the support is described in the following. The silica support preferably has a D50 of between 10 and 80 μm, preferably 18 and 50 μm. Furthermore, the silica support preferably has a D10 of between 5 and 30 μm and a D90 of between 30 and 90 μm.

The average particle size of the metallocene catalyst system is preferably of from 20 to 50 μm, more preferably of from 25 to 45 μm, and most preferably of from 30 to 40 μm.

The particle size distribution of the metallocene catalyst system is described in the following. The metallocene catalyst system preferably has a D50 of from 30 to 80 μm, preferably of from 32 to 50 μm and most preferably of from 34 to 40 μm. Furthermore, the metallocene catalyst system preferably has a D10 of at most 29 μm, more preferably of from 15 to 29 μm, more preferably of from 20 to 28 μm, and most preferably of from 25 to 27 μm. The metallocene catalyst system preferably has a D90 of at least 45 μm, more preferably of from 45 to 70 μm and most preferably of from 40 to 60 μm.

Preferably, the process for producing a heterophasic propylene copolymer composition comprises the steps of
a) preparing a bimodal matrix phase (A) of a heterophasic propylene copolymer by
   a1) polymerizing in a first reactor propylene to obtain a first propylene polymer fraction having a melt flow rate MFR2 of 25 to 85 g/10 min, determined according to ISO 1133 at 230° C. and 2.16 kg load, wherein a ratio of the feed of hydrogen to the feed of propylene is 0.10 to below 0.40 mol/kmol, preferably 0.15 to 0.39 mol/kmol, more preferably 0.20 to 0.38 mol/kmol, more preferably 0.20 to 0.38 mol/kmol, and most preferably 0.20 to 0.36 mol/kmol,
   a2) transferring the first propylene polymer fraction to a second reactor, and polymerizing in the second reactor propylene to obtain a second propylene polymer fraction, the combined first and second propylene polymer fractions have an MFR2 determined according to ISO 1133 at 230° C. and 2.16 kg load being at least 2.2 times higher than the MFR2 of the first propylene polymer fraction,
b) preparing a disperse phase (B) of the heterophasic propylene copolymer by
   b1) transferring the first propylene polymer fraction and the second propylene polymer fraction to a third reactor, and polymerizing in the third reactor propylene and an alpha-olefin having 2 or 4 to 12 carbon atoms to obtain a third propylene polymer fraction,
c) withdrawing the heterophasic propylene copolymer comprising the first, second and third propylene polymer fraction, and
d) obtaining the heterophasic propylene copolymer composition comprising the heterophasic propylene copolymer.
wherein the heterophasic propylene copolymer composition has a melt flow rate MFR2 of 70 to 250 g/10 min determined according to ISO 1133 at 230° C. and 2.16 kg load, and
wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I):

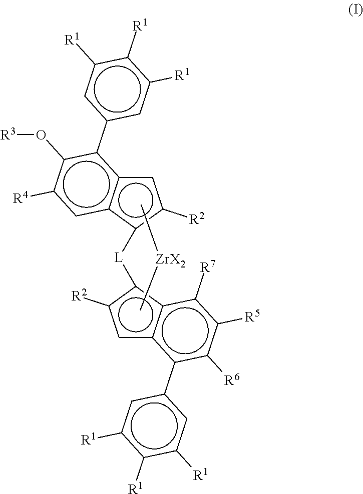

wherein each X independently is a sigma-donor ligand,
L is a divalent bridge selected from —R′₂C—, —R′₂C—CR′₂—, —R′₂Si—, —R′₂Si—SiR′₂—, and —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or different and are a CH₂—R⁸ group, with R⁸ being H or linear or branched C₁₋₆-alkyl group, C₃₋₈-cycloalkyl group, or C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and is selected from a C₁-C₂₀-hydrocarbyl group and a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

Preferably, the process for producing a heterophasic propylene copolymer composition comprises the steps of
a) preparing a bimodal matrix phase (A) of a heterophasic propylene copolymer by
   a1) polymerizing in a first reactor propylene to obtain a first propylene polymer fraction having a melt flow rate MFR2 of 25 to 85 g/10 min, determined according to ISO 1133 at 230° C. and 2.16 kg load,
   a2) transferring the first propylene polymer fraction to a second reactor, and polymerizing in the second reactor propylene to obtain a second propylene polymer fraction, the combined first and second propylene polymer fractions have an MFR2 determined according to ISO 1133 at 230° C. and 2.16 kg load being at least 2.2 times higher than the MFR2 of the first propylene polymer fraction, wherein a hydrogen to propylene feed ratio is in the range from more than 4.65 to 10.0 mol/kmol, more preferably 4.90 to 8.00 mol/kmol, more preferably 5.10 to 6.00 mol/kmol, more preferably 5.20 to 5.80 mol/kmol, and most preferably 5.30 to 5.70 mol/kmol,
b) preparing a disperse phase (B) of the heterophasic propylene copolymer by
   b1) transferring the first propylene polymer fraction and the second propylene polymer fraction to a third reactor, and polymerizing in the third reactor propylene and an alpha-olefin having 2 or 4 to 12 carbon atoms to obtain a third propylene polymer fraction,
c) withdrawing the heterophasic propylene copolymer comprising the first, second and third propylene polymer fraction, and
d) obtaining the heterophasic propylene copolymer composition comprising the heterophasic propylene copolymer.
wherein the heterophasic propylene copolymer composition has a melt flow rate MFR2 of 70 to 250 g/10 min determined according to ISO 1133 at 230° C. and 2.16 kg load, and
wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I):

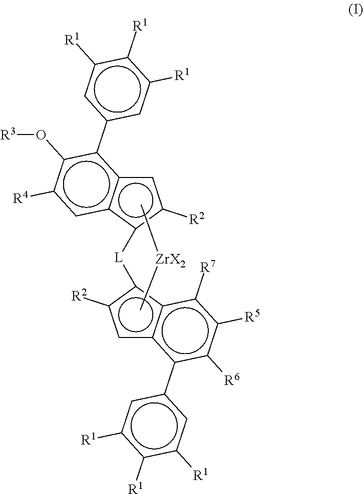

wherein each X independently is a sigma-donor ligand,
L is a divalent bridge selected from —R′₂C—, —R′₂C—CR′₂—, —R′₂Si—, —R′₂Si—SiR′₂—, and —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or different and are a CH₂—R⁸ group, with R⁸ being H or linear or branched C₁₋₆-alkyl group, C₃₋₈-cycloalkyl group, or C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and is selected from a C₁-C₂₀-hydrocarbyl group and a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

Preferably, the process for producing a heterophasic propylene copolymer composition comprises the steps of
a) preparing a bimodal matrix phase (A) of a heterophasic propylene copolymer by
   a1) polymerizing in a first reactor propylene to obtain a first propylene polymer fraction having a melt flow rate MFR2 of 25 to 85 g/10 min, determined according to ISO 1133 at 230° C. and 2.16 kg load, wherein a ratio of the feed of hydrogen to the feed of propylene is 0.10 to below 0.40 mol/kmol, preferably 0.15 to 0.39 mol/kmol, more preferably 0.20 to 0.38 mol/kmol, more preferably 0.20 to 0.38 mol/kmol, and most preferably 0.20 to 0.36 mol/kmol,
   a2) transferring the first propylene polymer fraction to a second reactor, and polymerizing in the second reactor propylene to obtain a second propylene polymer fraction, the combined first and second propylene polymer fractions have an MFR2 determined according to ISO 1133 at 230° C. and 2.16 kg load being at least 2.2 times higher than the MFR2 of the first propylene polymer fraction, wherein a hydrogen to propylene feed ratio is in the range from more than 4.65 to 10.0 mol/kmol, more preferably 4.90 to 8.00 mol/kmol, more preferably 5.10 to 6.00 mol/kmol, more preferably 5.20 to 5.80 mol/kmol, and most preferably 5.30 to 5.70 mol/kmol,
b) preparing a disperse phase (B) of the heterophasic propylene copolymer by
   b1) transferring the first propylene polymer fraction and the second propylene polymer fraction to a third reactor, and polymerizing in the third reactor propylene and an alpha-olefin having 2 or 4 to 12 carbon atoms to obtain a third propylene polymer fraction,
c) withdrawing the heterophasic propylene copolymer comprising the first, second and third propylene polymer fraction, and
d) obtaining the heterophasic propylene copolymer composition comprising the heterophasic propylene copolymer.
wherein the heterophasic propylene copolymer composition has a melt flow rate MFR2 of 70 to 250 g/10 min determined according to ISO 1133 at 230° C. and 2.16 kg load, and
wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I):

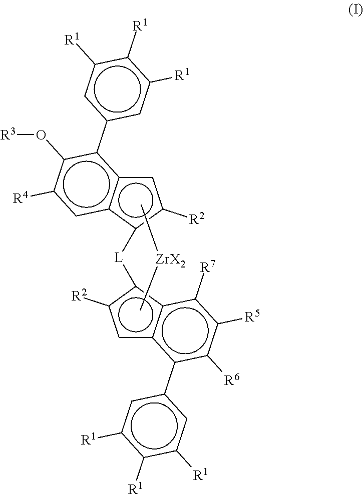

wherein each X independently is a sigma-donor ligand,
L is a divalent bridge selected from —R′₂C—, —R′₂C—CR′₂—, —R′₂Si—, —R′₂Si—SiR′₂—, and —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or different and are a CH₂—R⁸ group, with R⁸ being H or linear or branched C₁₋₆-alkyl group, C₃₋₈-cycloalkyl group, or C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and is selected from a C₁-C₂₀-hydrocarbyl group and a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

The invention further provides a heterophasic propylene copolymer composition obtained by the process according to the invention.

All preferred embodiments of the process for producing a heterophasic propylene copolymer composition according to the invention are also preferred embodiments of the heterophasic propylene copolymer composition obtained by the process according to the invention, if applicable.

The invention will now be further described by means of non-limiting examples.

### EXPERIMENTAL PART

### 1. DETERMINATION METHODS

The following definitions of terms and determination methods apply for the above general description of the invention as well as to the below examples unless otherwise defined.

### a) Melt Flow Rate (MFR)

The melt flow rate (MFR) was determined according to ISO 1133 and is indicated in g/10 min. The higher the melt flow rate, the lower the viscosity of the polymer. The MFR2 for polypropylene is determined at 230° C. and 2.16 kg load, and the MFR2 for polyethylene is determined at 190° C. and 2.16 kg.

The MFR2 of a fraction (B) produced in the presence of a fraction (A) is calculated using the measured values of MFR2 of the fraction (A) and the mixture received after producing fraction (B) (“final”):

$$Log ( {MFR}_{final} ) = weight fraction ( A ) * Log ( {MFR}_{A} ) + weight fraction ( B ) * Log ( {MFR}_{B} )$$

b) CRYSTEX: Determination of Crystalline and Soluble Fractions and their Respective Properties (IV and Ethylene Content)

The crystalline (CF) and soluble fractions (SF) of the polypropylene compositions as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (iV) an online 2-capillary viscometer is used.

The IR4 detector is a multiple wavelength detector measuring IR absorbance at two different bands (CH₃ stretching vibration (centered at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$\begin{matrix}Conc = a + b * Abs ( CH ) + c * {( Abs ( CH ) )}^{2} + \\ e * ( {Abs ( {CH}_{3} )}^{2} + f * Abs ( CH ) * Abs ( {CH}_{3} )\end{matrix} \qquad ( Equation 1 )$$

$$\begin{matrix}{CH}_{3} / 1000 C = a + b * Abs ( CH ) + c * Abs ( {CH}_{3} ) + d * ( Abs ( {CH}_{3} ) / Abs ( CH ) ) + e * \\ {( Abs ( {CH}_{3} ) / Abs ( CH ) )}^{2}\end{matrix} \qquad ( Equation 2 )$$

The constants a to e for equation 1 and a to f for equation 2 were determined by using least square regression analysis.

The CH₃/1000C is converted to the ethylene content in wt.-% using following relationship:

wt.-% (Ethylene in EP Copolymers)=100−CH₃/1000TC*0.3 (Equation 3)

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO 16152. XS calibration is achieved by testing various EP copolymers with XS content in the range 2-31 wt.-%. The determined XS calibration is linear:

$$wt . - \% XS = 1 , 01 * wt . - \% SF \qquad ( Equation 4 )$$

Intrinsic viscosity (iV) of the parent EP copolymer and its soluble and crystalline fractions are determined with a use of an online 2-capillary viscometer and are correlated to corresponding iV's determined by standard method in decalin according to ISO 1628-3. Calibration is achieved with various EP PP copolymers with iV=2-4 dL/g. The determined calibration curve is linear:

$$iV ( dL / g ) = a * Vsp / c \qquad ( Equation 5 )$$

The samples to be analyzed are weighed out in concentrations of 10 mg/ml to 20 mg/ml. To avoid injecting possible gels and/or polymers which do not dissolve in TCB at 160° C., like PET and PA, the weighed-out sample was packed into a stainless-steel mesh MW 0,077/D 0.05 mmm.

After automated filling of the vial with 1,2,4-TCB containing 250 mg/I 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV [dl/g] and the C2 [wt.-%] of the PP composition. During the second injection the soluble fraction (at low temperature) and the crystalline fraction (at high temperature) with the crystallization cycle are measured (wt.-% SF, wt.-% C2, iV).

### c) Xylene Cold Solubles (XCS)

The xylene cold solubles (XCS, wt.-%) were determined at 25° C. according to ISO 16152; first edition; 2005-07-01.

### d) Intrinsic Viscosity

Intrinsic viscosity was measured according to DIN ISO 1628/1, October 1999 (in Decalin at 135° C.).

### e) Quantification of Microstructure by NMR Spectroscopy—Ethylene Content in HECO

Quantitative nuclear-magnetic resonance (NMR) spectroscopy was used to quantify the comonomer content of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra. Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et al. (Wang, W-J., Zhu, S., Macromolecules 33 (2000), 1157) through integration of multiple signals across the whole spectral region in the ¹³C{¹H}spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( Sa β + S α y ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt . - \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### f) Flexural Modulus (FM)

The Flexural Modulus (FM) was determined in 3-point-bending according to ISO 178 on injection molded specimens as described in EN ISO 1873-2 with dimensions of 80×10×4 mm³. Crosshead speed was 2 mm/min for determining the flexural modulus.

### g) Charpy Notched Impact Strength (Charpy NIS)

Charpy Notched Impact Strength was determined according to ISO 179-1 eA at +23° C. or at −20° C. on injection molded specimens as described in EN ISO 1873-2 with dimensions of 80×10×4 mm³.

### h) Median Particle Size D50 (Sedimentation)

The median Particle Size D50 (Sedimentation) is calculated from the particle size distribution [mass percent] as determined by gravitational liquid sedimentation according to ISO 13317-3 (Sedigraph).

### i) Average Particle Size and Particle Size Distribution

The average particle size and particle size distribution was determined using laser diffraction measurements by Coulter LS 200. The average particle size and particle size distribution is a measure for the size of the particles. The D-values (D10 (or d10), D50 (or d50) and D90 (or d90)) represent the intercepts for 10%, 50% and 90% of the cumulative mass of sample. The D-values can be thought of as the diameter of the sphere which divides the sample's mass into a specified percentage when the particles are arranged on an ascending mass basis. For example the D10 is the diameter at which 10% of the sample's mass is comprised of particles with a diameter less than this value. The D50 is the diameter of the particle where 50% of a sample's mass is smaller than and 50% of a sample's mass is larger than this value. The D90 is the diameter at which 90% of the sample's mass is comprised of particles with a diameter less than this value. The D50 value is also called median particle size. From laser diffraction measurements according to ISO 13320 the volumetric D-values are obtained, based on the volume distribution.

### j) Differential Scanning Calorimetry (DSC)

Differential scanning calorimetry (DSC) analysis, melting temperature (Tₘ) and melt enthalpy (Hₘ), crystallization temperature (Tc), and heat of crystallization (H_{c}, H_{cr}) are measured with a TA Instrument Q200 differential scanning calorimetry (DSC) on 5 to 7 mg samples. DSC is run according to ISO 11357/part 3/method C₂ in a heat/cool/heat cycle with a scan rate of 10° C./min in the temperature range of −30 to +225° C.

Crystallization temperature (Tc) and heat of crystallization (H_{c}) are determined from the cooling step, while melting temperature (Tₘ) and melt enthalpy (Hₘ) are determined from the second heating step.

Throughout the description the term T_{c} or (T_{cr}) is understood as Peak temperature of crystallization as determined by DSC at a cooling rate of 10 K/min (i.e. 0.16 K/sec).

### k) Volatile Organic Compound (VOC) and Semi-Volatile Organic Condensable (FOG)

For the thermodesorption analysis according to VDA 278 (October 2011) the samples were stored uncovered at room temperature (23° C. max.) for 7 days directly before the commencement of the analysis.

VOC value is determined according to VDA 278 October 2011 from pellets. VDA 278 October 2011, Thermal Desorption Analysis of Organic Emissions for the Characterization of Non-Metallic Materials for Automobiles, VDA (Verband der Automobilindustrie). According to the VDA 278 October 2011 the VOC value is defined as “the total of the readily volatile to medium volatile substances. It is calculated as toluene equivalent. The method described in this Recommendation allows substances in the boiling/elution range up to n-Pentacosane (C₂₅) to be determined and analyzed.”

FOG value is determined according to VDA 278 October 2011 from pellets, too. According to the VDA 278 October 2011 the FOG value is defined as “the total of substances with low volatility which elute from the retention time of n-Tetradecane (inclusive). It is calculated as hexadecane equivalent. Substances in the boiling range of n-Alkanes “C₁₄” to “C₃₂” are determined and analyzed.”

### l) Bulk Density

The bulk density is determined on the polymer powder according to ISO 60:1977 at 23° C. using a 100 cm³ cylinder.

### 2. EXAMPLES

### a) Polymerization of the Heterophasic Propylene Copolymer Compositions

Catalyst A is a metallocene complex which has been used as described in WO 2019/179959 A1:

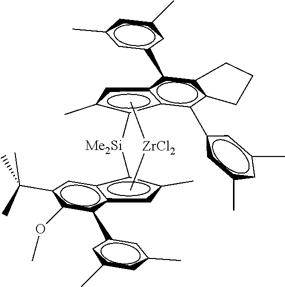

### [rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride]

The supported metallocene catalyst was produced analogously to IE2 in WO 2019/179959 A1.

Catalyst B is a Ziegler-Natta catalyst commercially available from Lyondell Basell under the tradename “Avant ZN180M”.

The comparative heterophasic propylene copolymer CE01 and the inventive heterophasic propylene copolymers IE01 and IE02 were prepared in a Borstar® PP pilot unit with sequential process comprising a prepolymerization reactor, a loop reactor and two gas phase reactors. Polymerization and reactor conditions are given in Table 1a below.

TABLE 1a
Preparation of the heterophasic propylene
copolymer using metallocene catalyst A

| Example | CE01 | IE01 | IE02 |
|---|---|---|---|
| Polymer Type | Unimodal | Bimodal | Bimodal |
| | matrix | matrix | matrix |
| Catalyst | A | A | A |

Prepolymerization reactor

| | | | |
|---|---|---|---|
| Temp. (° C.) | 20.0 | 20.0 | 20.0 |
| Press. (kPa) | 5124.4 | 5290.0 | 5282.8 |
| Catalyst feed (kg/h) | 2.88 | 2.34 | 2.33 |
| Feed H2/C3 ratio (mol/kmol) | 0.03 | 0.05 | 0.05 |
| Residence time (h) | 0.31 | 0.34 | 0.34 |

Loop reactor

| | | | |
|---|---|---|---|
| Temp. (° C.) | 70.0 | 70.0 | 70.0 |
| Press. (kPa) | 5327.0 | 5363.1 | 5367.1 |
| C3 feed (kg/h) | 197.80 | 198.95 | 198.53 |
| Feed H2/C3 ratio (mol/kmol) | 0.40 | 0.32 | 0.32 |
| Polymer Split (wt.-%) | 51 | 59 | 51 |
| Polymer residence time (h) | 0.38 | 0.39 | 0.39 |
| MFR2 loop (g/10 min) | 105 | 53.3 | 58.4 |
| Bulk Density (kg/m³) | 355 | 370 | 365 |

Gas phase reactor 1

| | | | |
|---|---|---|---|
| Temp. (° C.) | 80.0 | 75.0 | 75.0 |
| Press. (kPa) | 2500 | 2500 | 2500 |
| H2/C3 ratio (mol/kmol) | 4.60 | 5.50 | 5.50 |
| Polymer Split (wt.-%) | 40 | 32 | 37 |
| Residence time (h) | 2.5 | 1.9 | 1.8 |
| MFR2 loop + GPR1 (g/10 min) | 113 | 157 | 164 |
| MFR2 made in GPR1 (calculated) | 123 | 1167 | 850 |
| MFR2-ratio* | 1.1 | 2.9 | 2.8 |
| Bulk Density (kg/m³) | 355 | 390 | 382 |

Gas phase reactor 2

| | | | |
|---|---|---|---|
| Temp. (° C.) | 70.0 | 70.0 | 70.0 |
| Press. (kPa) | 2400 | 2400 | 2400 |
| H2/C2 ratio (mol/kmol) | 2.77 | 1.47 | 1.90 |
| H2/C3 ratio (mol/kmol) | 2.35 | 1.28 | 1.63 |
| C2/C3 ratio (mol/kmol) | 850.5 | 866.7 | 859.2 |
| Residence time (h) | 2.5 | 1.9 | 1.8 |
| Polymer Split (wt.-%) | 9 | 9 | 12 |
| Bulk Density (kg/m³) | 363 | 386 | 378 |

*MFR2(loop + GPR1)/MFR2(loop)

Comparative heterophasic propylene copolymer CE02 was prepared with sequential process comprising a prepolymerization reactor, a loop reactor and two gas phase reactors using catalyst B in combination with triethyl-aluminium (TEAL) as co-catalyst and dicyclopentadienyl-dimethoxy silane (donor D) as external donor. Polymerization and reactor conditions are given in Table 1b below.

TABLE 1b
Preparation of the heterophasic propylene copolymer compositions
using Ziegler-Natta catalyst B

| | | CE02 |
|---|---|---|
| Catalyst | | B |
| Donor | | D |
| Prepolymerization reactor | | |
| Co/ED | mol/mol | 10 |
| Co/Ti | mol/mol | 220 |
| Temperature | ° C. | 30 |
| Residence time | min | 5 |
| Loop reactor | | |
| Temperature | ° C. | 75 |
| Split | wt.-% | 52 |
| Feed H2/C3 | mol/kmol | 22.00 |
| MFR2(loop) | g/10 min | 160 |
| Gas phase reactor 1 | | |
| Temperature | ° C. | 80 |
| Split | wt.-% | 34 |
| H2/C3 | mol/kmol | 175.0 |
| MFR2(loop + GPR1) | g/10 min | 160 |
| MFR2(GPR1) | g/10 min | 160 |
| MFR2-ratio* | — | 1.0 |
| XCS | wt.-% | 2.0 |
| Gas phase reactor 2 | | |
| Temperature | ° C. | 80 |
| C2/C3 | mol/kmol | 550 |
| H2/C2 | mol/kmol | 250 |
| Split | wt.-% | 14 |
| MFR2 | g/10 min | 99 |
| Bulk density | kg/m³ | 350 |

*MFR2(loop + GPR1)/MFR2(loop)

Properties of the obtained heterophasic propylene copolymers CE01, IE01 and IE02 are shown in Table 2a below.

TABLE 2a
Properties of the heterophasic propylene copolymer

| Example | CE01 | IE01 | IE02 |
|---|---|---|---|
| MFR2 (g/10 min) | 100.0 | 110.0 | 99.4 |
| XCS (wt.-%) | 10.5 | 8.8 | 11.9 |
| IV(XCS)/XCS (ml/g) | 248 | 320 | 300 |

The heterophasic propylene copolymers IE01, IE02, CE01 and CE02 were compounded in a co-rotating twin-screw extruder Coperion ZSK 47 at 220° C. with 0.15 wt.-% antioxidant (Irganox B215FF from BASF AG, Germany; this is a 1:2-mixture of Pentaerythrityl-tetrakis(3-(3′,5′-5 di-tert. butyl-4-hydroxyphenyl)-propionate, CAS-no. 6683-19-8, and Tris (2,4-di-t-butylphenyl) phosphite, CAS-no. 31570-04-4) and 0.05 wt.-% of Ca-stearate (CAS-no. 1592-23-0, commercially available from Faci, Italy) as acid scavenger.

Properties of the obtained heterophasic propylene copolymer compositions are given in Table 2b below.

TABLE 2b
Properties of the heterophasic propylene copolymer compositions

| Total polymer | CE01 | CE02 | IE01 | IE02 |
|---|---|---|---|---|
| MFR2 (g/10 min) | 97 | 99 | 102 | 91 |
| XCS (wt.-%) | 10.5 | 15.0 | 8.8 | 11.9 |
| C2 (wt.-%) | 2.5 | 8.8 | 2.1 | 2.7 |
| C2 of XCS (wt.-%) | 23.8 | 44.0 | 23.3 | 23.4 |
| IV of XCS (dl/g) | 2.1 | 2.0 | 2.7 | 2.5 |
| Tm (° C.) | 153 | 165 | 151 | 152 |
| Tc (° C.) | 116 | 121 | 114 | 118 |

Crystex data

| | | | | |
|---|---|---|---|---|
| SF | 10.8 | 14.7 | 9.2 | 12.1 |
| CF | 89.2 | 85.3 | 90.8 | 87.9 |
| C2 | 2.5 | 8.8 | 2.1 | 2.7 |
| C2(SF) | 23.3 | 39.5 | 22.9 | 22.2 |
| C2(CF) | 0 | 3.5 | 0 | 0 |
| IV | 1.2 | 1.5 | 1.2 | 1.3 |
| IV(SF) | 2.2 | 2.9 | 2.8 | 2.7 |
| IV(CF) | 1.1 | 1.2 | 1.1 | 1.1 |

Further characterization

| | | | | |
|---|---|---|---|---|
| Flexural Modulus (MPa) | 1204 | 1380 | 1227 | 1172 |
| Charpy NIS at 23° C. | 2.9 | 4.0 | 3.6 | 4.2 |
| (kJ/m²) | | | | |
| VOC (μg/g) | 51 | 85 | 12 | 10 |
| FOG (μg/g] | 66 | 124 | 69 | 58 |

As can be seen from Table 2b above, the inventive examples IE01 and IE02 are comparable in stiffness and impact strength to the comparative examples. However, the VOC is at the same time significantly improved. In addition, the bulk density is improved.

1. Process for producing a heterophasic propylene copolymer composition, the process comprising the steps of
a) preparing a bimodal matrix phase (A) of a heterophasic propylene copolymer by
a1) polymerizing propylene in a first reactor to obtain a first propylene polymer fraction having a melt flow rate MFR2 of 25 to 85 g/10 min determined according to ISO 1133 at 230° C. and 2.16 kg load,
a2) transferring the first propylene polymer fraction to a second reactor, and polymerizing propylene in the second reactor to obtain a second propylene polymer fraction, the combined first and second propylene polymer fractions having an MFR2 determined according to ISO 1133 at 230° C. and 2.16 kg load being at least 2.2 times higher than the MFR2 of the first propylene polymer fraction,
b) preparing a disperse phase (B) of the heterophasic propylene copolymer by
b1) transferring the first propylene polymer fraction and the second propylene polymer fraction to a third reactor, and polymerizing in the third reactor propylene and an alpha-olefin having 2 or 4 to 12 carbon atoms to obtain a third propylene polymer fraction,
c) withdrawing from the third reactor the heterophasic propylene copolymer comprising the first, second and third propylene polymer fraction, and
d) obtaining the heterophasic propylene copolymer composition comprising the heterophasic propylene copolymer,
wherein the heterophasic propylene copolymer composition has a melt flow rate MFR2 of 70 to 250 g/10 min determined according to ISO 1133 at 230° C. and 2.16 kg load, and
wherein polymerizing in steps a1), a2) and b1) is conducted in the presence of a metallocene catalyst system, the metallocene catalyst system comprising a metallocene complex and a support, wherein the support comprises silica and wherein the metallocene complex is of formula (I): 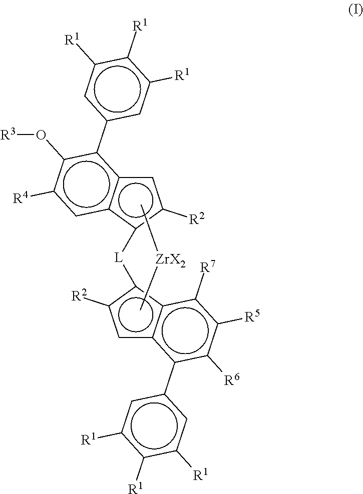
wherein each X independently is a sigma-donor ligand,
L is a divalent bridge selected from —R′₂C—, —R′₂C—CR′₂—, —R′₂Si—, —R′₂Si—SiR′₂—, and —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or different and are a CH₂—R³ group, with R³ being H or linear or branched C₁₋₆-alkyl group, C₃₋₃-cycloalkyl group, or C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group. with R⁹ being a linear or branched C₁-C₆-alkyl group.
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and is selected from a C₁-C₂₀-hydrocarbyl group and a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

2. The process according to claim 1, wherein the metallocene catalyst system further comprises (ii) a co-catalyst system comprising a boron containing co-catalyst and/or an aluminoxane co-catalyst.

3. The process according to claim 1, wherein the first propylene polymer fraction and/or the second propylene polymer fraction is/are propylene homopolymer fraction(s) and/or the third propylene polymer fraction is an ethylene-propylene rubber fraction

4. The process according to claim 1, wherein the combined first propylene polymer fraction and the second propylene polymer fraction form a bimodal propylene composition, preferably a bimodal propylene homopolymer composition.

5. The process according to claim 1, wherein the combined first and the second propylene polymer fractions have a melt flow rate MFR2 of 120 to 500 g/10 min determined according to ISO 1133 at 230° C. and 2.16 kg load.

6. The process according to claim 1, wherein the combined first and the second propylene polymer fractions have a fraction soluble in cold xylene at 25° C. (XCS fraction) determined according to ISO 16152 in an amount of less than 2.0 wt.-%, based on the total weight of the combined first and the second propylene polymer fractions.

7. The process according to claim 1, wherein the first propylene polymer fraction is produced in an amount of from 35 to 70 wt.-%, based on the total weight of the combined first, second and third propylene polymer fraction, and/or
wherein the second propylene polymer fraction is produced in an amount of from 25 to 55 wt.-%, based on the total weight of the combined first, second and third propylene polymer fraction, and/or
wherein the third propylene polymer fraction is produced in an amount of from 5 to 25 wt.-%, based on the total weight of the combined first, second and third propylene polymer fraction.

8. The process according to claim 1, wherein the first reactor is a slurry reactor, and/or wherein the second reactor is a first gas phase reactor (GPR1) and/or wherein the third reactor is a second gas phase reactor (GPR2).

9. The process according to claim 1, wherein the process further comprises the step of
b2) transferring the first propylene polymer fraction, the second polymer fraction and the third propylene copolymer fraction to a fourth reactor, the fourth reactor preferably being a third gas phase reactor (GPR3), and polymerizing in the fourth reactor propylene and an alpha-olefin having 2 or 4 to 12 carbon atoms to obtain a fourth propylene polymer fraction, the fourth propylene polymer fraction preferably being an ethylene-propylene rubber fraction,
wherein step b2) takes place after step b1) and before step c).

10. The process according to claim 1, wherein the heterophasic propylene copolymer comprises a fraction soluble in cold xylene at 25° C. (XCS fraction) determined according to ISO 16152 in an amount in the range of 6 to 22 wt.-%, based on the total weight of the heterophasic propylene copolymer.

11. The process according to claim 10, wherein the fraction soluble in cold xylene at 25° C. (XCS fraction) has an ethylene content (C2(XCS)) of 15 to 30 wt.-%, based on the total weight of the XCS fraction, as determined by Fourier transform infrared spectroscopy (FTIR) calibrated with ¹³C-NMR spectroscopy.

12. The process according to claim 1, wherein the heterophasic propylene copolymer has a total ethylene content (C2 total) in the range of 1.8 to 6.5 wt.-%, based on the total weight of the heterophasic propylene copolymer, as determined by Fourier transform infrared spectroscopy (FTIR) calibrated with ¹³C-NMR spectroscopy.

13. The process according to claim 1, wherein the heterophasic propylene copolymer composition has a melting temperature Tm in the range of 145 to 160° C. determined by differential scanning calorimetry (DSC) according to ISO 11357.

14. The process according to claim 1, wherein the heterophasic propylene copolymer composition has a crystallization temperature T_{c} in the range of 110 to 120° C. determined by differential scanning calorimetry (DSC) according to ISO 11357.

15. A heterophasic propylene copolymer composition obtained by the process according to claim 1.
